(19) United States
(12) Patent Application Publication
(10) Pub. No.: US 2026/0253348 A1
(43) Pub. Date: Aug. 27, 2026

(54) METHOD, APPARATUS, DEVICE AND STORAGE MEDIUM FOR GENERATING AN EFFECT

(71) Applicants: Lemon Inc., Grand Cayman (KY); Beijing Zitiao Network Technology Co., Ltd., Beijing (CN)

(72) Inventors: Long Jiang, Culver City, CA (US); Runze Zhang, Los Angeles, CA (US); Shiyuan Liu, Beijing (CN); Minqi Luo, Culver City, CA (US)

(21) Appl. No.: 19/549,786

(22) Filed: Feb. 25, 2026

(30) Foreign Application Priority Data
Feb. 25, 2025 (WO) PCT/CN2025/079081

(51) Int. Cl. G06T 19/00; H04N 5/262; G06F 8/35

(52) U.S. Cl. CPC G06T 19/006; H04N 5/262; G06F 8/35

(57) ABSTRACT

According to embodiments of the disclosure, a method and apparatus for generating an effect are provided. The method includes: generating, based on a received description text, a set of interaction media elements for placement in a virtual scene; generating a code content associated with at least one interaction media element of the set of interaction media elements, the code content describing interaction logic associated with the at least one interaction media element; and creating an effect file based on at least on the code content, wherein the effect file is configured to provide an effect associated with an augmented reality scene created based on collected image data. In this way, the embodiments of the disclosure can effectively improve the efficiency of generating an effect.

### CROSS-REFERENCE

This application claims priority to International Application No. PCT/CN2025/079081 , filed on Feb. 25, 2025 and entitled ‘METHOD, APPARATUS, DEVICE AND STORAGE MEDIUM FOR GENERATING AN EFFECT’, which is incorporated herein by reference in its entirety.

### FIELD

Example embodiments of the present disclosure generally relate to the field of computers, and in particular, to a method, apparatus, device, and computer-readable storage medium for generating an effect.

### BACKGROUND

Effect generation is an indispensable part of the field of digital entertainment such as film and television production and game development. Effect creating personnel may generate their desired effects through a series of complex processes such as three-dimensional modeling, texture mapping, animation rendering, and the like. It may be seen that generating an effect requires more professional effect editing knowledge. Therefore, how to simply and quickly generate an effect has become one of the core issues concerned in the field.

### SUMMARY

In a first aspect of the present disclosure, a method for generating an effect is provided. The method includes: generating, based on a received description text, a set of interaction media elements for placement in a virtual scene; generating a code content associated with at least one interaction media element of the set of interaction media elements, the code content describing interaction logic associated with the at least one interaction media element; and creating an effect file based on at least on the code content, where the effect file is configured to provide an effect associated with an augmented reality scene created based on collected image data

In a second aspect of the present disclosure, an apparatus for generating an effect is provided. The apparatus includes: a first generating module configured to generate, based on a received description text, a set of interaction media elements for placement in a virtual scene; a second generating module configured to generate a code content associated with at least one interaction media element of the set of interaction media elements, the code content describing interaction logic associated with the at least one interaction media element; and a creating module configured to create an effect file based on at least on the code content, where the effect file is configured to provide an effect associated with an augmented reality scene created based on collected image data.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method the first aspect.

In a fourth aspect of the present disclosure, a computer-readable storage medium is provided. The computer-readable storage medium has a computer program stored thereon, the computer program being executable by a processor to implement the method of the first aspect.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments according to the present disclosure may be implemented;

FIG. 2 illustrates a flowchart of an example process of generating an effect according to some embodiments of the disclosure;

FIG. 3 illustrates an example module diagram for generating an effect according to some embodiments of the present disclosure;

FIGS. 4A to 4C illustrate an example interface for generating an effect according to some embodiments of the present disclosure;

FIG. 5 illustrates a schematic structural block diagram of an example apparatus for generating an effect according to some embodiments of the present disclosure; and

FIG. 6 illustrates a block diagram of an electronic device capable of implementing various embodiments of the present disclosure.

### DETAILED DESCRIPTION

Embodiments of the present disclosure would be described in more detail below with reference to the accompanying drawings. While certain embodiments of the present disclosure are illustrated in the accompanying drawings, it would be appreciated that the present disclosure may be implemented in various forms and would not be construed as limited to the embodiments set forth herein. Rather, these embodiments are provided for a more thorough and complete understanding of the present disclosure. It would be appreciated that the drawings and embodiments of the present disclosure are for example purposes only and are not intended to limit the scope of the present disclosure.

It would be appreciated that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’ and the like would be understood to include ‘including but not limited to’. The term ‘based on’ would be understood as ‘based at least in part on’. The terms ‘one embodiment’ or ‘the embodiment’ would be understood as ‘at least one embodiment’. The term ‘some embodiments’ would be understood as ‘at least some embodiments’. Other explicit and implicit definitions may also be included below. The terms ‘first,’ ‘second,’ and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In the embodiments of the present disclosure, all data collection, acquisition, processing, handling, processing, reposting, use, and the like are carried out on the premise of the knowledge and confirmation of the user. Accordingly, when implementing the embodiments of the present disclosure, the types of the data or information that may be involved, the usage scope, the usage scenario, and the like would be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and may not affect the basic function of the user.

As mentioned above, effect generation is an indispensable part of the field of digital entertainment such as film production, game development, and the like. Effect creating personnel may generate their desired effects through a series of complex processes such as three-dimensional modeling, texture mapping, animation rendering, and the like. It may be seen that generating an effect requires more professional effect editing knowledge. Therefore, how to simply and quickly generate an effect has become one of the core issues concerned in the field.

The embodiment of the invention provides a scheme for generating an effect. The method includes: generating, based on a received description text, a set of interaction media elements for placement in a virtual scene; generating a code content associated with at least one interaction media element of the set of interaction media elements, the code content describing interaction logic associated with the at least one interaction media element; and creating an effect file based on at least on the code content, where the effect file is configured to provide an effect associated with an augmented reality scene created based on collected image data.

Based on this manner, the embodiments of the present disclosure can generate a set of interaction media elements placed in a virtual scene by a user based on a received description text, thereby improving the generation efficiency of the interaction media element. Further, the embodiments of the present disclosure generate the effect file through the code content associated with the interaction media element, so that the created effect file can be deployed into the augmented reality scene more quickly.

Therefore, the embodiment of the invention can improve the generation efficiency of the effect.

In this way, the embodiments of the present disclosure can generate, based on the received description text, a set of interaction media elements placed in a virtual object and an effect file corresponding to the set of interaction media elements, thereby improving the efficiency of the effect generation.

Various example implementations of this scheme are described in detail below in conjunction with the accompanying drawings.

### Example Environment

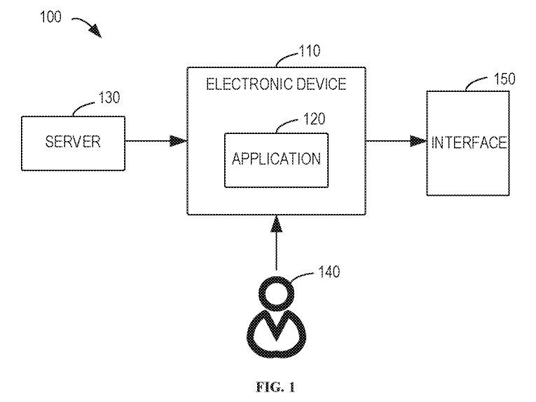

FIG. 1 illustrates a schematic diagram of an example environment 100 in which embodiments of the present disclosure may be implemented. As illustrated in FIG. 1, the example environment 100 may include an electronic device 110.

In this example environment 100, the electronic device 110 may run an application 120 that supports effect generation. The application 120 may be any suitable type of application for generating an effect, examples of which may include, but are not limited to: a social application, a content sharing application, an image editing application, or a further suitable application. A user 140 may interact with the application 120 via the electronic device 110 and/or its attachment device.

In the environment 100 of FIG. 1, if the application 120 is in an active state, the electronic device 110 may present, via the application 120, an interface 150 for supporting effect generation.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, or may be a server cluster or a distributed system composed of a plurality of physical servers, or may be a cloud server that provides basic cloud computing services such as cloud services, cloud databases, cloud computing, cloud functions, cloud storage, network services, cloud communications, middleware services, domain name services, security services, content distribution networks, big data and artificial intelligence platforms. The server 130 may include, for example, a computing system/server, such as a mainframe, an edge computing node, a computing device in a cloud environment, or the like. The server 130 may provide background services for applications 120 that support effect generation in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments of the present disclosure are not limited in this aspect. In an embodiment of the present disclosure, the server 130 and the electronic device 110 may implement signaling interaction through a communication connection therebetween.

It would be appreciated that the structures and functions of the various elements in the environment 100 are described for example purposes only and do not imply any limitation to the scope of the present disclosure.

Some example embodiments of the present disclosure will be described below with continued reference to the accompanying drawings.

### Example Processes

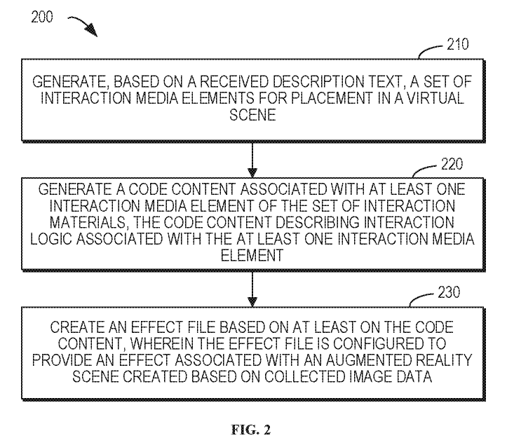

FIG. 2 illustrates a flowchart of an example process 200 of generating an effect according to some embodiments of the present disclosure. The process 200 may be implemented at the electronic device 110. The process 200 is described below with reference to FIG. 1.

Generally, various interaction media elements in a virtual scene are manually configured by developers. In this way, the material generation efficiency is relatively low, and after the developers complete the rendering of the interaction media element, a corresponding interaction media element may be generated only by many operations such as rendering the interaction media element.

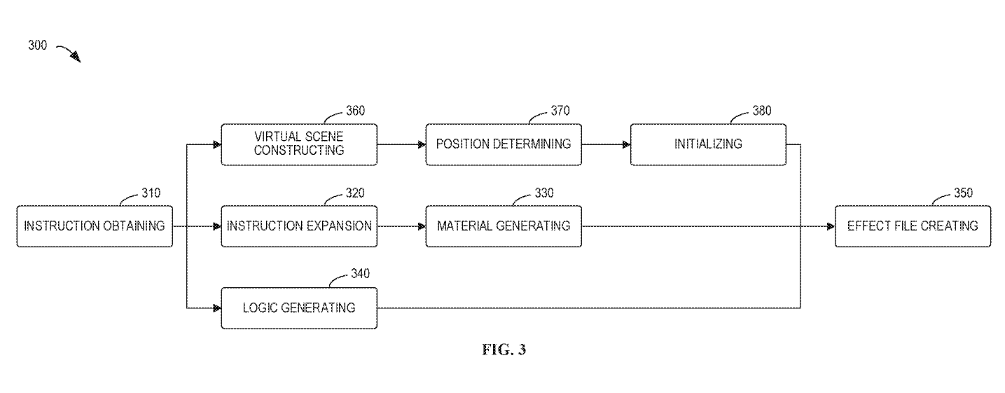

In view of this, embodiments of the present disclosure can support generating an interaction media element based on a description text input by a user. Specifically, as shown in FIG. 2, at block 210, the electronic device 110 generates, based on a received description text, a set of interaction media elements for placement in a virtual scene. As an example, as shown in FIG. 3, FIG. 3 illustrates a module diagram for generating an effect according to some embodiments of the present disclosure. The electronic device 110 may receive the description text input by the user through an instruction obtaining module 310. Such description text may be, for example, a request for creating an effect in an augmented reality (AR) scene, for example, “please create an effect for collecting pizza”. In some scenarios, the description text may also be a description text of the style of the material to be generated, for example, “Please create a green apple”. Such description text may also be richer and more accurate, for example, “please place a green apple in the left corridor”, and through richer and more accurate description text, an interaction media element with a better effect may be generated.

After obtaining the description text, the electronic device 110 may invoke a material generating module 330 to generate a set of interaction media elementinteraction media elements based on the description text. When the generation of the interaction media element is performing, the electronic device 110 may write the description text to a language model through the material generating module 330 to generate the set of interaction media elements. The interaction media element is generated through the language model, and the developer does not need to manually draw and create the interaction media element, so that the generation efficiency of the interaction media element can be effectively improved.

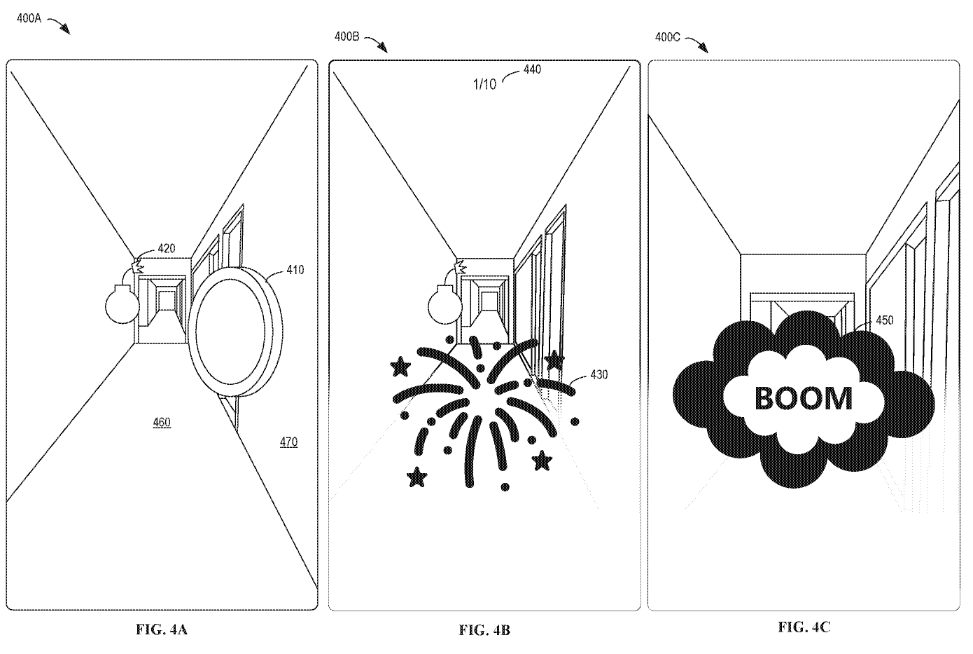

Alternatively or in addition, as shown in FIG. 4A, FIGS. 4A to 4C illustrate some example interfaces of embodiments of the present disclosure. After receiving the description text, the electronic device 110 may generate a set of interaction media elements through a language model. For example, the description text is “please create an effect for collecting pizza for me.” The electronic device 110 may provide the description text to the language model to generate an interaction media element 410 and an interaction media element 420 presented in an interface 400A shown in FIG. 4A. The style of the interaction media element 410 may be “pizza”, and the style of the interaction media element 420 may be “bomb”.

In some embodiments, the electronic device 110 may further generate a set of interaction media elements based on the description information of the virtual scene. The description information is determined based on first image data. Such first image data is associated with a virtual scene, and the first image data may be collected by the electronic device 110. As an example, after obtaining the first image data, the electronic device 110 may determine the description information of the virtual scene based on the first image data. Such description information may be, for example, description of attributes such as spatial distribution of various items and virtual scenes in the virtual scene. Further, the electronic device 110 may provide the description information of the virtual scene to the language model, so that the language model generates the interaction media element matching the virtual scene based on the description information of the virtual scene.

For example, the virtual scene is a beach scene. The description information associated with the beach scene is a description of each item and spatial distribution in the beach. After the electronic device 110 provides the description information of the beach scene to the language model, the language model may generate interaction elements such as a sunshade, a coconut tree, and a sailboat.

The interaction media element is generated through the description information of the virtual scene, so that the generated interaction media element is enabled to be more natural in the virtual scene, so that the interaction experience of the user can be effectively improved.

In a real scenario, a prompt (that is, a description text) input by a user is usually relatively simple. When the language model generates the interaction media element based on a simpler prompt, it is difficult to ensure the quality of the generated interaction media element. Based on this, in some embodiments, the electronic device 110 may obtain a first prompt input by a user. Further, the electronic device 110 may generate the description text by rewriting the first prompt.

As an example, after obtaining the first prompt, the electronic device 110 may invoke an instruction expansion module 320 to expand or rewrite the first prompt to obtain the description text. For example, the electronic device 110 may provide the first prompt to the language model to expand or rewrite the description text through the language model. For example, the first prompt may be “Please create an effect for collecting pizza,” after the electronic device 110 provides the description text to the language model, the obtained description text may be “Please design an effect, and the effect needs to have a main function, that is, collecting pizza. Requirement: the effect has sufficient detail and features to enable the player to get a better effect experience. At the same time, the effect needs to accommodate players of different ages and experiences. Please ensure the security of effects, and no malicious programs or security vulnerabilities exist.”

In some scenarios, when rewriting the first prompt, the electronic device 110 may further provide the related image data to the language model to obtain the description text. For example, the first prompt may be “please create an effect for collecting pizza,” and the image data provided to the language model may be an image of a corridor. Then, the expanded description text obtained through the language model may be “Please design an effect, and the effect needs to have a main function, that is, collecting pizza. Requirement: the pizza needs to be placed in a area that is not occupied by other objects in the corridor, so as to ensure that the pizza is not placed at a position where the player cannot reach.” By expanding the description text, the description text can be richer and more accurate, so that the quality of subsequent generation of the interaction media element may be improved.

With continued reference to FIG. 2, at block 220, the electronic device 110 generates a code content associated with at least one interaction media element of the set of interaction media elements, the code content describing interaction logic associated with the at least one interaction media element. The interaction logic indicates at least one of: an interaction manner associated with the at least one interaction media element, visual feedback during interaction with the at least one interaction media element, audio feedback during interaction with the at least one interaction media element, or credit feedback during interaction with the at least one interaction media element.

As an example, as shown in FIG. 3, the electronic device 110 may invoke a logic generating module 340 to generate a code content of the interaction media element. Such code content may be used, for example, to describe the interaction logic of the interaction media element. For example, as shown in FIG. 4A, the electronic device 110 may generate a code content associated with the interaction media element 410 through the logic generating module 340. Such code content may be used, for example, to describe an interaction manner, visual feedback, audio feedback, and credit feedback of the interaction media element 410. The interaction manner may be, for example, a user touching the interaction media element 410, observing the interaction media element 410, reaching the position where the interaction media element 410 is located, and the like. The visual feedback may be a visual effect (for example, an animation effect) presented in the interface 400A after the user interacts with the interaction media element 410. The audio feedback may be a music effect triggered and played after the user interacts with the interaction media element 410. The credit feedback may be, for example, a credit reward triggered after the user interacts with the interaction media element 410.

In some embodiments, the electronic device 110 may determine a logic description text of the interaction logic. Further, the electronic device 110 may provide a logic description text to the language model to generate a code content associated with the at least one interaction media element.

As an example, before generating the code content of the interaction media element, the electronic device 110 may first determine a logic description text indicating the interaction logic. When determining the logic description text, to improve the generation efficiency of the code content, the electronic device 110 may search a text database for the logic description text matching the description text based on the description text. Such a logic description text may be, for example, “when the user interacts with the pizza, presenting an animation of fireworks blooming and a corresponding audio effect, and adding a credit”. Such text database may be, for example, a database communicatively connected to the server 130, and when the electronic device 110 needs to obtain data in the text database, the electronic device 110 may send an obtaining request to the server 130 to obtain data in the text database.

Further, the electronic device 110 may adjust the language model by the logic generating module 340 shown in FIG. 3 to generate a code content associated with the at least one interaction media element.

In some embodiments, in order to make the logic description text better satisfy the user's needs, the electronic device 110 may also invoke the language model to generate the logic description text. Specifically, the electronic device 110 may obtain the second prompt input by the user. Further, the electronic device 110 may determine the logic description text based on the second prompt.

As an example, after the electronic device 110 obtains the second prompt input by the user, the second prompt may be provided to the language model to generate the logic description text associated with the second prompt. The second prompt may be, for example, “please give me an interaction effect after a pizza is hit”. After the electronic device 110 provides the second prompt to the language model, the obtained logic description text may be “1. a visual effect, including: a flash animation, a deformation effect, an example effect; 2. a sound effect, including: a crisp sound effect, a feedback sound effect; 3. an interface feedback, including: credit increasing, achievement prompt”. Using the language model to generate the logic description text is able to make the obtained logic description text more consistent with the requirement of the user, so as to improve the quality of the generated code content.

With continued reference to FIG. 2, at block 230, the electronic device 110 creates an effect file based on at least on the code content, where the effect file is configured to provide an effect associated with an augmented reality scene created based on collected image data. As an example, as shown in FIG. 3, after obtaining the code content, the electronic device 110 may create an effect file based on the code content by using the effect file creating module 350. Since the code content for creating the effect file is created based on the interaction logic of the interaction media element in the virtual scene, the effect file created through the code content can more conveniently provide related effects to the plurality of interaction media elements in the augmented reality scene.

In some embodiments, the electronic device 110 may receive a virtual scene creation request triggered by a user and create a corresponding virtual scene. The creation process of the virtual scene may be performed before the set of interaction media elements is generated, or after the effect file is created. Specifically, the electronic device 110 may construct a virtual scene based on the image data. Such image data includes first image data collected before the set of interaction media elements is generated; or second image data collected by running the effect file.

As an example, as shown in FIG. 3, before creating a set of interaction media elements, the electronic device 110 may obtain the first image data through a camera device connected thereto. Such a camera device may be, for example, a camera placed in the electronic device 110 or a camera communicatively connected to the electronic device 110. Such first image data may be, for example, an image captured by the electronic device 110 by invoking the camera or may be image data determined by the electronic device 110 based on the point cloud data. After obtaining the first image data, the electronic device 110 may invoke a virtual scene constructing module 360 to construct the virtual scene. Such a virtual scene may be, for example, a virtual corridor scene as shown in FIG. 4A. The virtual scene is created before the interaction media element is created, so that the subsequently generated interaction media element may be more accurately added to a corresponding position in the virtual scene, so that the presenting effect of the interaction media element in the virtual scene may be improved.

As a further example, the electronic device 110 may further collect a second image when running the effect file to construct a virtual scene. When the effect file is run, the electronic device 110 may obtain the second image through the camera device. Further, after the electronic device 110 obtains the second image, the virtual scene may be constructed by the virtual scene constructing module 360. When virtual scene may be constructed when the effect file is running, the effect may be directly provided to the virtual scene through the already created effect file, thus saving the time of adding the effect.

Further, the electronic device 110 may determine a virtual spatial distribution of the virtual scene. As an example, after constructing the virtual scene, the electronic device 110 may determine a spatial distribution of the virtual scene. Specifically, the electronic device 110 may determine, based on the image data, a spatial layout, an object position, and a lighting condition of the real scene recorded in the image data. Further, the electronic device 110 may determine the virtual spatial distribution based on the spatial layout, the object position, and the lighting condition. For example, the electronic device 110 may determine, based on a wall in the image data, a position of a virtual element corresponding to the wall in the virtual scene to determine spatial distributions of respective objects in the virtual scene.

After determining the virtual spatial distribution of the virtual scene, the electronic device 110 may determine, based on the virtual spatial distribution, a placement position of the set of interaction media elements in the virtual scene. As an example, as shown in FIG. 3, the electronic device 110 may invoke a position determining module 370 to determine, based on the virtual spatial distribution, a placement position of a set of interaction media elements in the virtual scene. For example, as shown in FIG. 4A, an area 460 is above the floor in the virtual scene, and an area 470 is a wall. In this case, when the placement position of the interaction media element in the virtual scene is determined, the electronic device 110 may determine the area 460 as the placement position of the interaction media element without occupying the area 470 occupied by the wall as the placement position of the interaction media element.

In some scenarios, after determining the placement position of the interaction media element in the virtual scene, the electronic device 110 may generate a setting of a scene object and a corresponding initial object in the virtual scene with an initializing module 380.

In some embodiments, the electronic device 110 may further determine the placement position based on a material type of the set of interaction media elements. As an example, as shown in FIG. 4A, when the interaction media element is a wall picture, the electronic device 110 selects the area 470 as the placement position of the wall picture.

In some embodiments, the electronic device 110 may determine, based on its own position information, a virtual position in the augmented reality scene. Further, the electronic device 110 may trigger a response action associated with the set of materials based on a positional relationship between the virtual position and the set of materials in the augmented reality scene.

As an example, as shown in FIGS. 4A to 4B, after the interaction media element generated by the electronic device 110 is added to the virtual scene, the electronic device 110 may present the interface 400A. The interface 400A includes the interaction media element 410 and the interaction media element 420 generated by the electronic device 110. When the position of the user (that is, the position information of the electronic device) overlaps the interaction media element 410, the electronic device 110 may present the animation effect 430 (for example, an animation of fireworks blooming) shown in FIG. 4B to the user, and play the corresponding audio effect (for example, a sound effect of fireworks blooming). Additionally, the electronic device 110 may also present a count component 440 in the interface 400B. The counting component 440 is configured to count the number of interactions between the user and the interaction media element 410. When the position of the user overlaps the interaction media element 410, the electronic device 110 may increase the number of interactions between the user and the interaction media element 410 and update the counting component 440.

In some other scenarios, as shown in FIG. 4C, when the position of the user (that is, the position information of the electronic device) overlaps the interaction media element 410, the electronic device 110 may present the animation effect 440 (for example, an animation of bomb explosion) to the user, and play a corresponding audio effect (for example, a sound effect of bomb explosion).

Based on this manner, the embodiments of the present disclosure can generate a set of interaction media elements that the user places in the virtual scene based on the received description text, thereby improving the generation efficiency of the interaction media element. Further, the embodiments of the present disclosure generate the effect file through the code content associated with the interaction media element, so that the created effect file may be deployed into the augmented reality scene more quickly.

### Example Apparatus and Device

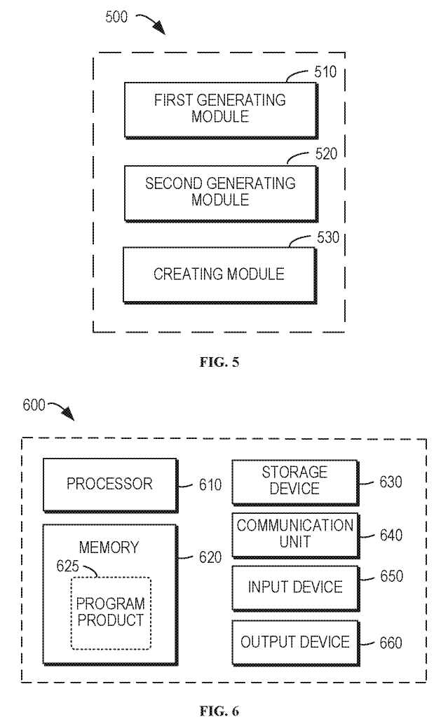

Embodiments of the present disclosure also provide a corresponding apparatus for implementing the above methods or processes. FIG. 5 illustrates a schematic structural block diagram of an example apparatus 500 for effect generation according to some embodiments of the present disclosure. The apparatus 500 may be implemented or included in the electronic device 110. The various modules/components in the apparatus 500 may be implemented by hardware, software, firmware, or any combination thereof.

As shown in FIG. 5, the apparatus 500 includes: a first generating module 510 configured to generate, based on a received description text, a set of interaction media elements for placement in a virtual scene; a second generating module 520 configured to generate a code content associated with at least one interaction media element of the set of interaction media elements, the code content describing interaction logic associated with the at least one interaction media element; and a creating module 530 configured to create an effect file based on at least on the code content, where the effect file is configured to provide an effect associated with an augmented reality scene created based on collected image data.

In some embodiments, the image data includes: first image data collected before the set of interaction media elements is generated; or second image data collected by running the effect file.

In some embodiments, the apparatus 500 further includes a constructing module configured to construct the virtual scene based on the image data; determine a virtual spatial distribution of the virtual scene; and determine, based on the virtual spatial distribution, a placement position of the set of interaction media elements in the virtual scene.

In some embodiments, the placement position is further determined based on a material type of the set of interaction media elements.

In some embodiments, the set of interaction media elements are further generated based on description information of the virtual scene, and the description information is determined based on the first image data.

In some embodiments, the apparatus 500 further includes an obtaining module configured to obtain a first prompt input by a user; and generate the description text by rewriting the first prompt.

In some embodiments, the second generating module 520 is further configured to: determine a logic description text indicating the interaction logic; and provide the logic description text to a language model to generate the code content associated with the at least one interaction media element.

In some embodiments, the second generating module 520 is further configured to: obtain a second prompt input by a user; and determine the logic description text based on the second prompt.

In some embodiments, the interaction logic indicates at least one of: an interaction manner associated with the at least one interaction media element, visual feedback during interaction with the at least one interaction media element, audio feedback during interaction with the at least one interaction media element, or credit feedback during interaction with the at least one interaction media element.

In some embodiments, an electronic device running the effect file is further configured to: determine a virtual position in the augmented reality scene based on position information of the electronic device; and trigger a response action associated with the set of materials based on a positional relationship between the virtual position and the set of materials in the augmented reality scene.

As shown in FIG. 6, the electronic device 600 is in a form of a general-purpose electronic device. Components of the electronic device 600 may include, but are not limited to, one or more processors or processing units 610, memory 620, storage device 630, one or more communication units 640, one or more input devices 650, and one or more output devices 660.The processor 610 may be an actual or virtual processor and is capable of performing various processes based on programs stored in the memory 620. In a multiprocessor system, a plurality of processors performs computer-executable instructions in parallel to improve the parallel processing capability of the electronic device 600.

The electronic device 600 typically includes a plurality of computer storage media. Such media may be any available media accessible to the electronic device 600, including, but not limited to, volatile and non-volatile media, removable and non-removable media. The memory 620 may be volatile memory (e.g., register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, a disk, or any other medium that may be capable of storing information and/or data and may be accessible within the electronic device 600.

The electronic device 600 may further include additional removable/non-removable, volatile/non-volatile storage media. Although not illustrated in FIG. 6, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not illustrated) by one or more data media interfaces. The memory 620 may include a computer program product 626 having one or more program modules that are configured to perform various methods or actions of various embodiments of the present disclosure.

The communication unit 640 implements communication with other electronic devices via a communication medium. Additionally, the functions of the components of the electronic device 600 may be implemented as a single computing cluster or a plurality of computing machines that are capable of communicating over a communication connection. Thus, the electronic device 600 may use logical connections to one or more other servers, networked personal computers (PCs), or a further network node to operate in a networked environment.

The input device 650 may be one or more input devices, such as a mouse, a keyboard, a tracking ball, and the like. The output device 660 may be one or more output devices, such as a monitor, a speaker, a printer, and the like. The electronic device 600 may also communicate, as desired, via the communication unit 640, with one or more external devices (not illustrated), external devices such as storage devices, display devices, etc., with one or more devices that enable a user to interact with the electronic device 600, or with any device that enables the electronic device 600 to communicate with one or more other electronic devices (e.g., a network card, modem, etc.) to communicate. Such communication may be performed via an input/output (I/O) interface (not illustrated).

According to an example implementation of the present disclosure, there is provided a computer-readable storage medium having computer-executable instructions stored thereon, where the computer-executable instructions are performed by a processor to implement the method described above. According to an example implementation of the present disclosure, there is also provided a computer program product, the computer program product being tangibly stored on a non-transient computer-readable medium and including computer-executable instructions, where the computer-executable instructions are performed by a processor to implement the methods described above.

Aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that causes the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different sequence than noted in the figures. For example, two consecutive blocks may actually be performed substantially in parallel, which may sometimes be performed in the reverse sequence, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations would be apparent to those of ordinary skill in the art without departing from the scope and spirit of the various implementations illustrated. The determination of the terms used herein is intended to best explain the principles of the implementations, practical applications, or improvements to techniques in the marketplace, or to enable others of ordinary skill in the art to understand the various implementations disclosed herein.

What is claimed is:

1. A method for generating an effect, comprising:
generating, based on a received description text, a set of interaction media elementsfor placement in a virtual scene;
generating a code content associated with at least one interaction media element of the set of interaction media elements, the code content describing interaction logic associated with the at least one interaction media element; and
creating an effect file based on at least on the code content, wherein the effect file is configured to provide an effect associated with an augmented reality scene created based on collected image data.

2. The method of claim 1, wherein the image data comprises:
first image data collected before the set of interaction media elements is generated; or
second image data collected during the effect file is running.

3. The method of claim 2, further comprising:
constructing the virtual scene based on the image data;
determining a virtual spatial distribution of the virtual scene; and
determining, based on the virtual spatial distribution, a placement position of the set of interaction media elements in the virtual scene.

4. The method of claim 3, wherein the placement position is further determined based on a material type of the set of interaction media elements.

5. The method of claim 2, wherein the set of interaction media elements are further generated based on description information of the virtual scene, and the description information is determined based on the first image data.

6. The method of claim 1, further comprising:
obtaining a first prompt input by a user; and
generating the description text by rewriting the first prompt.

7. The method of claim 1, wherein generating the code content associated with the at least one interaction media element of the set of interaction media elements comprises:
determining a logic description text indicating the interaction logic; and
providing the logic description text to a language model to generate the code content associated with the at least one interaction media element.

8. The method of claim 7, wherein determining the logic description text indicating the interaction logic comprises:
obtaining a second prompt input by a user; and
determining the logic description text based on the second prompt.

9. The method of claim 1, wherein the interaction logic indicates at least one of:
an interaction manner associated with the at least one interaction media element,
visual feedback during interaction with the at least one interaction media element,
audio feedback during interaction with the at least one interaction media element, or
credit feedback during interaction with the at least one interaction media element.

10. The method of claim 1, wherein an electronic device running the effect file is further configured to:
determine a virtual position in the augmented reality scene based on position information of the electronic device; and
trigger a response action associated with the set of materials based on a positional relationship between the virtual position and the set of materials in the augmented reality scene.

11. An electronic device, comprising:
at least one processor; and
at least one memory coupled to the at least one processor and storing instructions for execution by the at least one processor, the instructions, when executed by the at least one processor, causing the electronic device to perform acts comprising:
generating, based on a received description text, a set of interaction media elements for placement in a virtual scene;
generating a code content associated with at least one interaction media element of the set of interaction media elements, the code content describing interaction logic associated with the at least one interaction media element; and
creating an effect file based on at least on the code content, wherein the effect file is configured to provide an effect associated with an augmented reality scene created based on collected image data.

12. The electronic device of claim 11, wherein the image data comprises:
first image data collected before the set of interaction media elements is generated; or
second image data collected during the effect file is running.

13. The electronic device of claim 12, wherein the acts further comprises:
constructing the virtual scene based on the image data;
determining a virtual spatial distribution of the virtual scene; and
determining, based on the virtual spatial distribution, a placement position of the set of interaction media elements in the virtual scene.

14. The electronic device of claim 13, wherein the placement position is further determined based on a material type of the set of interaction media elements.

15. The electronic device of claim 12, wherein the set of interaction media elements are further generated based on description information of the virtual scene, and the description information is determined based on the first image data.

16. The electronic device of claim 11, wherein the acts further comprises:
obtaining a first prompt input by a user; and
generating the description text by rewriting the first prompt.

17. The electronic device of claim 11, wherein generating the code content associated with the at least one interaction media element of the set of interaction media elements comprises:
determining a logic description text indicating the interaction logic; and
providing the logic description text to a language model to generate the code content associated with the at least one interaction media element.

18. The electronic device of claim 17, wherein determining the logic description text indicating the interaction logic comprises:
obtaining a second prompt input by a user; and
determining the logic description text based on the second prompt.

19. The electronic device of claim 11, wherein the interaction logic indicates at least one of:
an interaction manner associated with the at least one interaction media element,
visual feedback during interaction with the at least one interaction media element,
audio feedback during interaction with the at least one interaction media element, or
credit feedback during interaction with the at least one interaction media element.

20. A non-transitory computer-readable storage medium having a computer program stored thereon, the computer program being executable by a processor to perform acts comprising:
generating, based on a received description text, a set of interaction media elements for placement in a virtual scene;
generating a code content associated with at least one interaction media element of the set of interaction media elements, the code content describing interaction logic associated with the at least one interaction media element; and
creating an effect file based on at least on the code content, wherein the effect file is configured to provide an effect associated with an augmented reality scene created based on collected image data.
